(19) United States
(12) Patent Application Publication
(10) Pub. No.: US 2017/0255149 A1
(43) Pub. Date: Sep. 7, 2017

(54) NIP-FORMING MEMBER, FIXING UNIT, AND IMAGE FORMING APPARATUS

(71) Applicants: Hiromasa TAKAGI, Tokyo (JP); Yasunori ISHIGAYA, Kanagawa (JP); Kazuya SAITO, Kanagawa (JP); Toshihiko SHIMOKAWA, Kanagawa (JP); Keitaro SHOJI, Kanagawa (JP)

(72) Inventors: Hiromasa TAKAGI, Tokyo (JP); Yasunori ISHIGAYA, Kanagawa (JP); Kazuya SAITO, Kanagawa (JP); Toshihiko SHIMOKAWA, Kanagawa (JP); Keitaro SHOJI, Kanagawa (JP)

(21) Appl. No.: 15/433,667

(22) Filed: Feb. 15, 2017

(30) Foreign Application Priority Data
Mar. 3, 2016 (JP) 2016-041567
Apr. 13, 2016 (JP) 2016-080560

(51) Int. Cl. G03G 15/20

(52) U.S. Cl. CPC G03G 15/2085

(57) ABSTRACT

A nip-forming member includes: a first nip-forming member configured to be a main body of the nip-forming member; and a second nip-forming member disposed on a surface of the first nip-forming member, the surface facing the inner circumferential surface, the second nip-forming member extending in a direction orthogonal to a rotating direction of the fixing belt. Both ends of the second nip-forming member on an upstream side and a downstream side of the rotating direction are bent in a direction away from the nipping part, in order to create a pair of side-wall portions, so that the second nip-forming member has a concave cross-section for accommodating the first nip-forming member. The second nip-forming member has a restraining portion at a position located on the side-wall portion created on the upstream side, the restraining portion being configured to restrain the first nip-forming member not to be detached from the concave cross-section.

### CROSS-REFERENCE TO RELATED APPLICATIONS

The present application claims the benefit of priority under 35 U.S.C. §119 of Japanese Patent Application No. 2016-041567, filed Mar. 3, 2016, and Japanese Patent Application No. 2016-080560, filed Apr. 13, 2016, the contents of which are incorporated herein by reference in their entirety.

### BACKGROUND OF THE INVENTION

1. Field of the Invention

The present disclosure relates to nip-forming members, fixing units provided with nip-forming members, and image forming apparatuses provided with fixing units.

2. Description of the Related Art

As a fixing unit mounted on an image forming apparatus such as an electrophotographic copier and printer, a belt-type fixing unit with enhanced energy-conservation performance and improved first-print-time has been in practical use. Such a belt-type fixing unit heats up an endless fixing belt using a heating member such as a halogen heater. In recent years, a direct heating method, in which a fixing belt with low heat-capacity is directly heated up by a heating member (e.g. a halogen heater), has been in widespread use.

As for such a direct heating method, ideally, a fixing belt is heated up in a heating width that corresponds to each size of paper widths. However, in practice, in a case of employing a general halogen heater as a heating member, there are a limited number of heaters (e.g. a central heater and end heater) compared to the number of sizes of paper widths, in view of cost saving, etc.

Conventionally, there has been a practice for reducing temperature-rise on end portions of the fixing belt, which occurs along with passing of a small sized paper, by use of a high heat-conducting member as disclosed in FIG. 10 of Japanese Unexamined Patent Application Publication No. 2015-194661, which is attached to a nip-forming member that forms a fixing nip of a fixing unit.

### SUMMARY OF THE INVENTION

One aspect of the present invention provides a nip-forming member arranged in contact with an inner circumferential surface of a rotatable endless fixing belt, the nip-forming member being counter-acted by a counterpart member from an outer circumferential side of the fixing belt so as to form a nipping part, which is a contacting section of the fixing belt and the counterpart member. The nip-forming member includes: a first nip-forming member configured to be a main body of the nip-forming member; and a second nip-forming member disposed on a surface of the first nip-forming member, the surface facing the inner circumferential surface of the fixing belt, the second nip-forming member extending in a direction orthogonal to a rotating direction of the fixing belt. Both ends of the second nip-forming member on an upstream side and a downstream side of the rotating direction of the fixing belt are bent in a direction away from the nipping part, in order to create a pair of side-wall portions, so that the second nip-forming member has a concave cross-section for accommodating the first nip-forming member. The second nip-forming member has a restraining portion at a position located on the side-wall portion created on the upstream side of the rotating direction, the restraining portion being configured to restrain the first nip-forming member not to be detached from the concave cross-section.

### BRIEF DESCRIPTION OF THE DRAWINGS

FIG. 1 is a schematic view of an image forming apparatus, according to an embodiment of the present invention;

FIG. 2 is a schematic view of an example of a fixing unit employed for the image forming apparatus, according to the embodiment of the present invention;

FIG. 3A is a cross-sectional view of a stay and a nip-forming member, which is taken along line a-a illustrated in FIG. 3B and viewed in a paper-passing direction, according to the embodiment of the present invention;

FIG. 3B is a lateral cross-sectional view of the stay and the nip-forming member, according to the embodiment of the present invention;

FIGS. 4A and 4B are perspective views of the nip-forming member illustrated in FIGS. 3A and 3B, according to the embodiment of the present invention;

FIG. 5A is a cross-sectional view of the nip-forming member provided on the fixing unit, according to the embodiment of the present invention;

FIG. 5B is a cross-sectional view taken along line B-B illustrated in FIG. 5C, which illustrates a state of putting a base of the nip-forming member and a high heat-conducting member together, according to the embodiment of the present invention;

FIG. 5C is a perspective view illustrating the state of putting the base of the nip-forming member and the high heat-conducting member together, according to the embodiment of the present invention;

FIG. 6 is a drawing illustrating an arrangement-relation between heating members and the high heat-conducting member, according to the embodiment of the present invention;

FIG. 7A is a cross-sectional view of a variation of the nip-forming member, according to the embodiment of the present invention;

FIG. 7B is a cross-sectional view illustrating a state of putting the base of the nip-forming member and the high heat-conducting member together in the variation, according to the embodiment of the present invention; and

FIG. 7C is a perspective view of the nip-forming member in the variation, according to the embodiment of the present invention.

### DESCRIPTION OF THE EMBODIMENTS

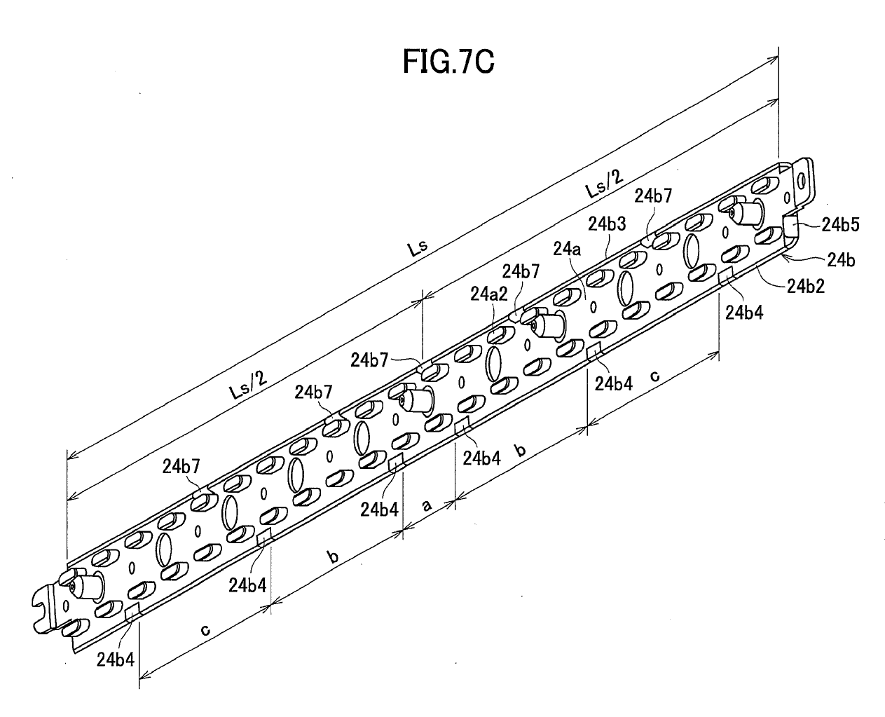

Although a high heat-conducting member is required to be thin-walled so as to achieve low heat-capacity in order not to cause delay in rise-time or first-print-time, a thin-walled high heat-conducting member is subject to positional misalignment and deformation due to friction against a fixing belt, which tends to cause fixing malfunction. Although the high heat-conducting member according to Japanese Unexamined Patent Application Publication No. 2015-194661 has a concave cross-section (see FIG. 7) for accommodating a base that constitutes a main body of a nip-forming member by use of a predetermined jig, there has been a risk for positional misalignment and deformation due to employment of such a thin-walled high heat-conducting member.

Therefore, the object of the present invention is to provide a high heat-conducting member that is highly resistant to positional misalignment and deformation even in a thin-walled design.

As a nip-forming member according to the present invention has a second nip-forming member provided with a restraining portion on an upstream side of rotation of a fixing belt, positional misalignment and deformation may be prevented even though the second nip-forming member is designed to be thin-walled.

(Image Forming Apparatus)

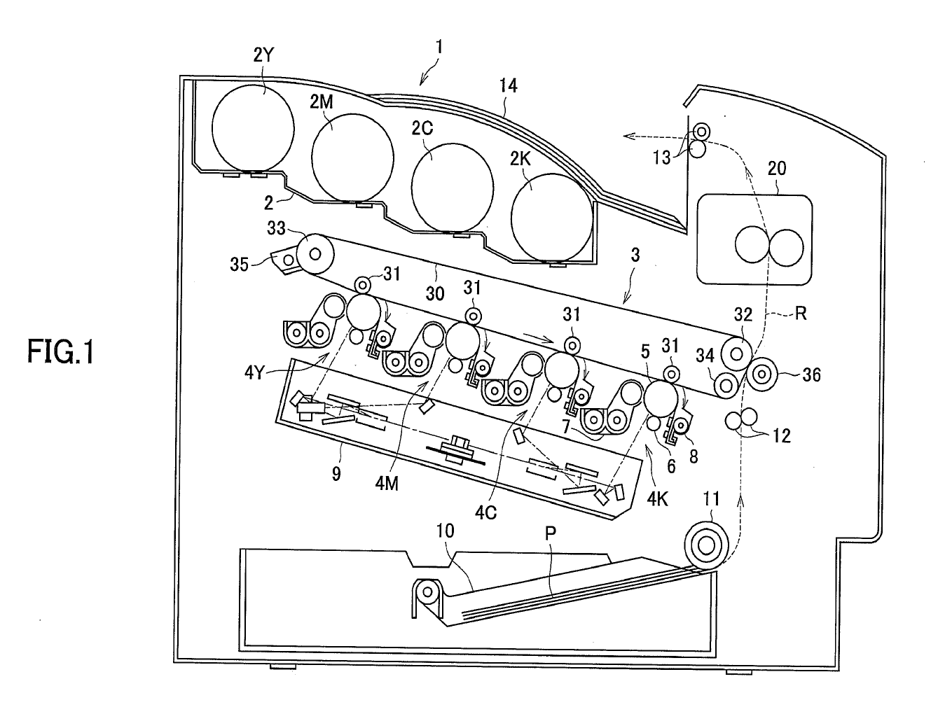

The following description explains a printer, which is an example of an image forming apparatus according to the embodiment of the present invention, as well as a fixing unit and a nip-forming member that are employed for the printer, with reference to drawings. FIG. 1 is a drawing illustrating a schematic configuration of an electrophotographic color laser printer, which is an example of an image forming apparatus 1. At the center of the image forming apparatus 1 are provided four image formation mechanisms 4Y, 4M, 4C, and 4K. Image formation mechanisms 4Y, 4M, 4C, and 4K have similar configurations, except that the image formation mechanisms 4Y, 4M, 4C, and 4K house developers of different colors of yellow (Y), magenta (M), cyan (C), and black (K), respectively, which correspond to color separation components of a color image.

In detail, each of the image formation mechanisms 4Y, 4M, 4C, and 4K includes a drum-shaped photoconductor 5 as a latent image bearer, a charging unit 6 for charging the surface of the photoconductor 5, a developing device 7 that provides toner onto the surface of the photoconductor 5, a cleaning unit 8 for cleaning the surface of the photoconductor 5, etc. Here, in FIG. 1, reference symbols are assigned to the photoconductor 5, the charging unit 6, the developing device 7, and the cleaning unit 8, for the image formation mechanism 4K of black color; accordingly the same reference symbols are omitted with respect to the other image formation mechanisms 4Y, 4M, and 4C.

Below each of the image formation mechanisms 4Y, 4M, 4C, and 4K is disposed an exposure unit 9 as a latent image forming unit that exposes the surface of the photoconductor 5 to form an electrostatic latent image. The exposure unit 9 includes a light source, a polygon mirror, an f-θ lens, a reflection mirror, etc., and is configured to irradiate the surface of each of the photoconductors 5 with a laser beam, based on image data. Here, the exposure unit 9 may be configured as a light-emitting diode (LED) exposure unit as well.

Above each of the image formation mechanisms 4Y, 4M, 4C, and 4K is disposed a transfer unit 3. The transfer unit 3 includes an intermediate transfer belt 30 as a transfer body, four first transfer rollers 31 as first transfer members, and a second transfer roller 36 as a second transfer member. The transfer unit 3 further includes a second transfer backup roller 32, a cleaning backup roller 33, a tension roller 34, and a belt cleaning unit 35.

The intermediate transfer belt 30 is an endless belt, which is tensed over the second transfer backup roller 32, the cleaning backup roller 33, and the tension roller 34. Here, the intermediate transfer belt 30 runs in circle (i.e. rotates) in a direction indicated by an arrow in FIG. 1, in accordance with rotary drive of the second transfer backup roller 32.

The four first transfer rollers 31 form first transfer nips, having the intermediate transfer belt 30 nipped with the photoconductors 5, respectively. Furthermore, a power source is connected to each of the first transfer rollers 31, so that a predetermined amount of direct-current (DC) electricity and/or alternating-current (AC) electricity is applied to each of the first transfer rollers 31.

The second transfer roller 36 forms a second transfer nip, having the intermediate transfer belt 30 nipped with the second transfer backup roller 32. Furthermore, similarly to the first transfer rollers 31, a power source is connected to the second transfer roller 36 as well, so that a predetermined amount of direct-current (DC) electricity and/or alternating-current (AC) electricity is applied to the second transfer roller 36.

The belt cleaning unit 35 includes a cleaning brush and a cleaning blade, which are disposed so as to abut the intermediate transfer belt 30. A waste toner transporting hose, which extends from the belt cleaning unit 35, is connected to an inlet part of a waste toner container.

The upper side of the printer body is provided with a bottle container 2. In the bottle container 2 are detachably loaded four toner bottles 2Y, 2M, 2C, and 2K which contain toner supply. Between the toner bottles 2Y, 2M, 2C, and 2K and the developing devices 7 are provided supply routes, through which toner is supplied from the toner bottles 2Y, 2M, 2C, and 2K to the developing devices 7, respectively.

Additionally, the lower side of the printer body is provided with a sheet feeding tray 10 which contains a paper P as a recording medium, a sheet feeding roller 11 that takes the paper P out of the sheet feeding tray 10, etc. Here, the recording medium may be, other than a regular paper, a cardboard, a letter, an envelope, a thin paper, a coated paper (e.g. a coated-type paper, an art paper, etc.), a tracing paper, an overhead projector (OHP) sheet, etc. Furthermore, a manual paper feeding mechanism may be provided on a side of the printer body.

Inside the printer body is disposed a conveyance route R, on which the paper P in the sheet feeding tray 10 passes through the second transfer nip to be ejected to the outside of the apparatus. On an upstream side of the conveyance route R in the sheet-conveyance direction, viewed from the position of the second transfer roller 36, is disposed a pair of timing rollers 12 as a conveyance member for conveying the paper P to the second transfer nip.

Furthermore, on a downstream side in the sheet-conveyance direction, viewed from the position of the second transfer roller 36, is disposed a fixing unit 20 for fixing an un-fixed image transferred onto the paper P. Further, on a downstream side of the conveyance route R in the sheet-conveyance direction, viewed from the position of the fixing unit 20, is disposed a pair of paper ejection rollers 13 for ejecting the paper P to the outside of the apparatus. Further, on a top surface part of the printer body is provided a paper ejection tray 14 for placing the paper P ejected out from the apparatus.

(Basic Operation of the Printer)

The following description explains a basic operation of the printer according to the embodiment of the present invention, with reference to FIG. 1. When an image formation operation is initiated, a driving unit performs rotary drive of the photoconductors 5 of the respective image formation mechanisms 4Y, 4M, 4C, and 4K in the clockwise direction as illustrated in FIG. 1, so that the surfaces of the photoconductors 5 are charged by the charging units 6 uniformly to a predetermined polarity.

The charged surfaces of the photoconductors 5 are irradiated with respective laser beams emitted from the exposure unit 9, so that electrostatic latent images are formed on the surfaces of the photoconductors 5, respectively. Here, image information for exposing each of the photoconductors 5 is unicolor image information, which is color information of yellow, magenta, cyan, or black separated from a desired full color image. The developing devices 7 provide toner onto the electrostatic latent images formed on the respective photoconductors 5 in such a way, in order to visualize (i.e. to make into visible images) the electrostatic latent images into toner images.

Furthermore, when the image formation operation is initiated, the second transfer backup roller 32 is driven to rotate in the counterclockwise direction as illustrated in FIG. 1, so that the intermediate transfer belt 30 runs in circle in the direction indicated by the arrow in FIG. 1. Then, an electric voltage, on which constant voltage control or constant current control is performed so that the electric voltage has the reversed polarity of the polarity of charged toner, is applied to each of the first transfer rollers 31. Then, transfer electric fields are formed at the first transfer nips between the respective first transfer rollers 31 and photoconductors 5.

Then, as the photoconductors 5 rotate, when the toner images of different colors formed on the photoconductors 5 reach the first transfer nips, respectively, the toner images on the photoconductors 5 are transferred onto the intermediate transfer belt 30 in order, so that the toner images are superimposed on each other, due to the transfer electric fields formed at the first transfer nips. In such a way, a full color toner image is borne on the surface of the intermediate transfer belt 30.

Furthermore, toner staying on the photoconductors 5 without being transferred onto the intermediate transfer belt 30 is removed by the cleaning unit 8. Then, residual charge on the surface of each of the photoconductors 5 is removed by a residual charge removing unit, in order to initialize surface potential.

On the lower side of the printer body, the sheet feeding roller 11 is driven to rotate, so as to convey the paper P from the sheet feeding tray 10 to the conveyance route R. The paper P conveyed to the conveyance route R is further conveyed to the second transfer nip between the second transfer roller 36 and the second transfer backup roller 32, at a timing determined by the timing rollers 12. Here, to the second transfer roller 36 is applied an electric voltage for transfer, which has the reversed polarity of the polarity of charged toner forming the toner image on the intermediate transfer belt 30, so that a transfer electric field is formed at the second transfer nip.

Then, as the intermediate transfer belt 30 runs in circle, when the toner image formed on the intermediate transfer belt 30 reaches the second transfer nip, the toner image formed on the intermediate transfer belt 30 is transferred onto the paper P at once, due to the transfer electric field formed at the second transfer nip. Further, residual toner staying on the intermediate transfer belt 30 without being transferred onto the paper P at the moment is removed by the belt cleaning unit 35. The removed toner is conveyed to and collected in the waste toner container.

Then, the paper P is conveyed to the fixing unit 20, so that the toner image formed on the paper P is fixed on the paper P by the fixing unit 20. Then, the paper P is ejected to the outside of the apparatus by the paper ejection rollers 13 to be placed on the paper ejection tray 14.

Although the above description explains an image forming operation for forming a full color image on a sheet, a unicolor image may be formed by use of any one of the four image formation mechanisms 4Y, 4M, 4C, and 4K, or an image in two or three colors may be formed by use of two or three of the image formation mechanisms 4Y, 4M, 4C, and 4K.

(Fixing Unit)

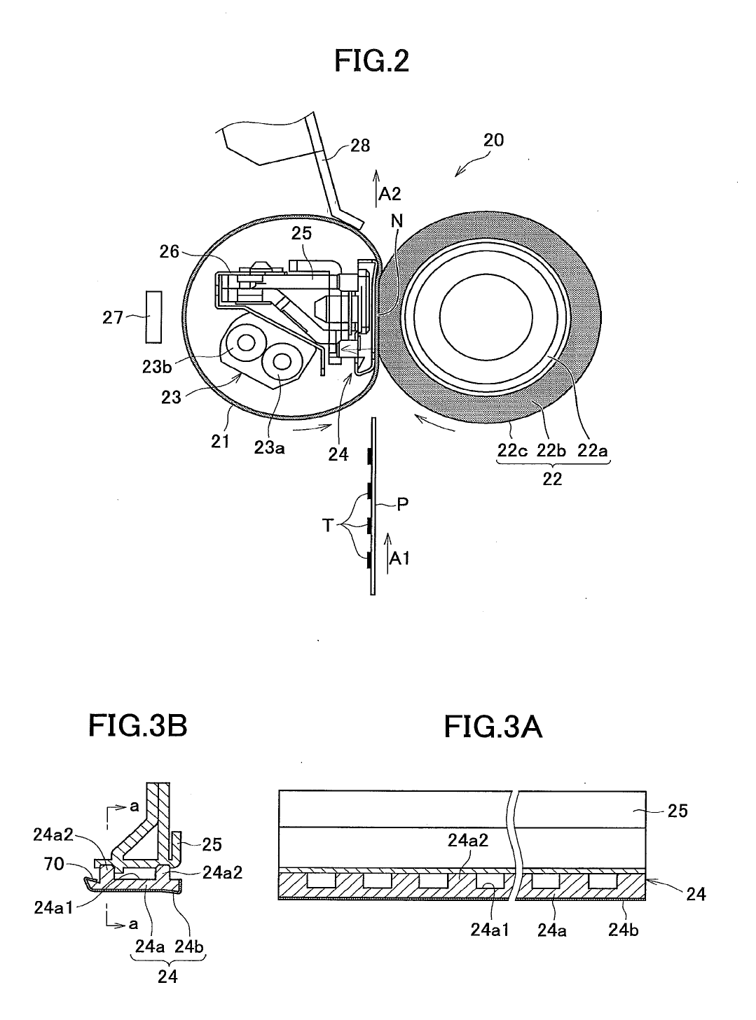

The following description explains a configuration of the fixing unit 20 employed for the printer, with reference to FIG. 2. As illustrated in FIG. 2, the fixing unit 20 includes a fixing belt 21, which is a rotatable fixing rotation body, and a pressure applying roller 22, which is provided so as to be rotatable at a position counter to the fixing belt 21 as a counterpart member (i.e. a counterpart rotation body).

Further, the fixing unit 20 includes halogen heaters 23 (i.e. a central heater 23a and end heater 23b) as a heating member that applies heat on the fixing belt 21, a nip-forming member 24 which is disposed on the inner side of the fixing belt 21, and a stay 25 as a supporting member that supports the nip-forming member 24. Further, the fixing unit 20 includes a reflecting member 26 that reflects rays emitted by the halogen heaters 23 towards the fixing belt 21, a temperature sensor 27 as a temperature detecting member that detects temperature of the fixing belt 21, a detaching member 28 that detaches the paper P from the fixing belt 21, a pressure applying member that applies pressure to the fixing belt 21 with the pressure applying roller 22, etc.

The fixing belt 21 may be constituted by thin flexible endless belt members (incl. films) with low heat-capacity. Specifically, the fixing belt 21 may be constituted by an inner circumferential base which is formed by metal material such as nickel or steel special use stainless (SUS) or by resin material such as polyimide (PI), as well as an outer circumferential releasing layer which is formed by tetrafluoroethylene and perfluoro-alkyl-vinyl-ether copolymer (PFA) or polytetrafluoroethylene (PTFE). Further, an elastic layer, which is formed by rubber material such as silicone rubber, silicone foam rubber, fluoro-rubber, etc., may be formed between the base and the releasing layer.

The pressure applying roller 22 is constituted by a cored bar 22a, an elastic layer 22b provided on the surface of the cored bar 22a, which is formed by silicone foam rubber, silicone rubber, fluoro-rubber, etc., and a releasing layer 22c provided on the surface of the elastic layer 22b, which is formed by PFA or PTFE, etc. The pressure applying roller 22 is pressed towards the fixing belt 21 by the pressure applying member, so as to counter-act the nip-forming member 24 via the fixing belt 21.

A nipping part N having a predetermined width is formed at the position where the pressure applying roller 22 and the fixing belt 21 are pressed against each other, as the elastic layer 22b of the pressure applying roller 22 is being compressed. Further, the pressure applying roller 22 is driven to rotate by a driving source such as a motor provided inside the printer. When the pressure applying roller 22 is driven to rotate, the driving force is transmitted to the fixing belt 21 at the nipping part N, so that the fixing belt 21 is driven to rotate. Then, when the paper P having a transferred toner image T is conveyed in direction A1 to the nipping part N, the toner image T is fixed on the paper P at the nipping part N. Then, the paper P is ejected from the nipping part N in direction A2.

Although the pressure applying roller 22 is a solid roller in the embodiment of the present invention, the pressure applying roller 22 may alternatively be a hollow roller. In such a case, the heating member such as a halogen heater may be disposed inside the pressure applying roller 22. Further, although, in a case of no elastic layers, fixing performance may be improved because of reduction in heat-capacity, minute protuberances on the belt surface may cause gloss noise on a solid part of an image at the time of pressing and fixing unfixed toner, as marks due to the protuberances are transferred onto the image.

In order to prevent such gloss noise, it is desired that an elastic layer of more than 100 μm thick is provided. An elastic layer of more than 100 μm thick may absorb such effect of the minute protuberances due to elastic deformation of the elastic layer, and therefore prevent gloss noise. The elastic layer 22b may be formed by solid rubber, or by sponge rubber in a case of not providing a heating member inside the pressure applying roller 22.

Sponge rubber, which takes less heat away from the fixing belt 21 due to high heat-insulation property, is preferable in terms of energy-conservation. Furthermore, the fixing rotation body and the counterpart rotation body need not be pressed to each other, and may be configured to simply make contact with each other without application of pressure.

Both end portions of each of the halogen heaters 23 are fixed to the side walls of the fixing unit 20. Each of the halogen heaters 23 is configured to produce heat in accordance with output control performed by a power source unit provided in the printer body. The output control is based on a detection result of surface-temperature of the fixing belt 21, which is obtained by the temperature sensor 27. Because of the output control of the halogen heaters 23, temperature (i.e. fixing-temperature) of the fixing belt 21 may be set as desired. Furthermore, other than a halogen heater, an induction heater (IH), a resistance heating element, a carbon heater, etc., may be employed as a heating member for applying heat to the fixing belt 21.

The nip-forming member 24 is disposed longitudinally along an axis of the fixing belt 21 or the pressure applying roller 22, and supported by the stay 25 to be fixed. In such a way, deflection on the nip-forming member 24 caused by pressure due to the pressure applying roller 22 is prevented, so that an even nip width is maintained along the axis of the pressure applying roller 22. Here, the stay 25 is preferably formed by metal material such as stainless steel or iron to achieve high mechanical-strength that is sufficient for such a deflection-preventing function of the nip-forming member 24, although the stay 25 may be formed by resin material.

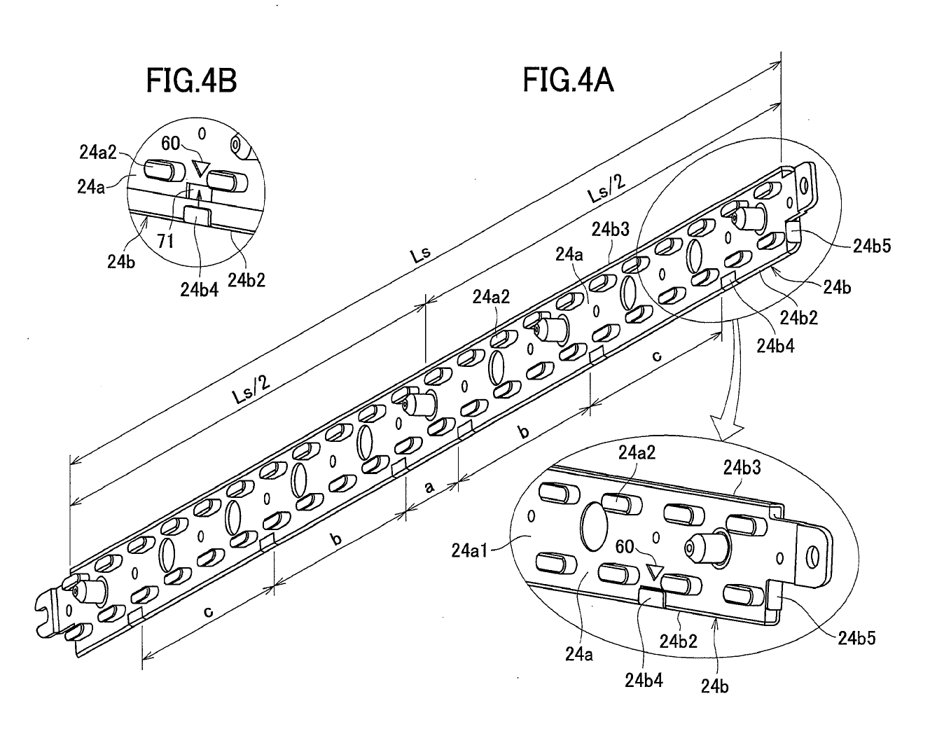

Further, the nip-forming member 24 may be constituted by heat-resistant members having heat-resistance temperatures of more than 200° C. Therefore, deformation of the nip-forming member 24 due to heat in the range of toner fixing temperature is prevented, so that a stable state of the nipping part N is ensured and a stable quality of an output image is maintained. A base of the nip-forming member 24 may be formed by general heatproof resin as described below with reference to FIGS. 3A and 3B. In the embodiment of the present invention, as described below, liquid crystal polymer (LCP), which has preferable heat-resistance and formability, is employed for a base 24a of the nip-forming member 24.

Furthermore, the nip-forming member 24 is provided with a low-friction sheet on the surface. As the fixing belt 21 slides on the low-friction sheet while rotating, the load on the fixing belt 21 due to frictional force is lessened and driving torque for the fixing belt 21 is reduced. Preferable material for the low-friction sheet is, for example, TOYOFLON (registered trademark) manufactured by Toray.

The reflecting member 26 is disposed between the stay 25 and the halogen heaters 23. In the embodiment of the present invention, the reflecting member 26 is fixed to the stay 25. Further, as the reflecting member 26 is directly heated by the halogen heaters 23, it is preferable that the reflecting member 26 is formed by metal material, etc., of high melting point.

As the reflecting member 26 is disposed in such a way, rays emitted by the halogen heaters 23 towards the stay 25 is reflected towards the fixing belt 21. Therefore, the amount of rays emitted towards the fixing belt 21 may be increased, and efficient application of heat to the fixing belt 21 is possible. Further, conduction of radiant heat from the halogen heaters 23 to the stay 25, etc., may be reduced, which may contribute to energy-conservation.

Furthermore, instead of disposing the reflecting member 26 as described in the embodiment of the present invention, mirror finish treatment, such as polishing or coating, may be implemented on a surface of the stay 25 on the side facing the halogen heaters 23, so as to form a reflection surface. Further, the reflectance rate of the reflecting member 26 or the reflection surface of the stay 25 is preferably more than 90%.

As selections of the form and material for the stay 25 are limited in order to ensure strength, separate disposition of the reflecting member 26 as described in the embodiment of the present invention may broaden options of the form and material, so that the reflecting member 26 and the stay 25 may be specialized in the respective functions. Further, when the reflecting member 26 is disposed between the halogen heaters 23 and the stay 25, the distance from the halogen heaters 23 to the reflecting member 26 is short, and therefore efficient application of heat to the fixing belt 21 is possible.

Furthermore, in order to improve heat-application efficiency of reflected rays to the fixing belt 21, consideration of the orientation of the reflecting member 26 or the reflection surface of the stay 25 may be necessary. For example, when the stay 25 is disposed so that the reflection surface is on a concentric circle having the halogen heaters 23 at the center, heat-application efficiency is reduced for the amount of rays reflecting towards the halogen heaters 23. Instead, when the stay 25 is disposed in an angle so that a part or the entire surface of the reflection surface faces in a direction to reflect rays towards the fixing belt 21, not towards the halogen heaters 23, heat-application efficiency may be improved, as less amount of rays is reflected towards the halogen heaters 23.

Furthermore, the fixing unit 20 according to the embodiment of the present invention has various structural features, in order to enhance energy-conservation performance or to improve first-print-time, etc. Specifically, a part of the fixing belt 21, other than the nipping part N, is configured to be heated directly by the halogen heaters 23 (i.e. direct heating method). In the embodiment of the present invention, nothing is provided between the halogen heaters 23 and the left side part of the fixing belt 21 illustrated in FIG. 2, so that radiant heat from the halogen heaters 23 is applied directly to the part of the fixing belt 21.

Furthermore, for the purpose of reducing heat-capacity, the fixing belt 21 is designed to be thin and to have small diameter. Specifically, thickness of the base, elastic layer, and releasing layer, which constitute the fixing belt 21, are designed to be in a range of 20 to 50 μm, 100 to 300 μm, and 10 to 50 μm, respectively, and are designed to be thinner than 1 mm altogether.

Furthermore, the diameter of the fixing belt 21 is designed to be in a range of 20 to 40 mm. For the purpose of further decreasing heat-capacity, the thickness of the fixing belt 21 as a whole is preferably designed to be thinner than 0.2 mm, and further preferably to be thinner than 0.16 mm. Furthermore, it is preferable that the diameter of the fixing belt 21 is designed to be smaller than 30 mm.

Here, in the embodiment of the present invention, the diameter of the pressure applying roller 22 is designed to be from 20 to 40 mm, so that the fixing belt 21 and the pressure applying roller 22 have diameters of the same size, although configurations of the fixing belt 21 and the pressure applying roller 22 are not limited to be as such. Alternatively, for example, the diameter of the fixing belt 21 may be smaller than the diameter of the pressure applying roller 22. In such a case, as the curvature of the fixing belt 21 at the nipping part N is larger than the curvature of the pressure applying roller 22, the paper P is easily detached from the fixing belt 21 when being ejected from the nipping part N in direction A2.

(Nip-Forming Member)

The following description explains the nip-forming member 24 according to the embodiment of the present invention, with reference to FIGS. 3A through 6. As illustrated in FIGS. 3A and 3B, the nip-forming member 24 is constituted by a base 24a as a first nip-forming member and a high heat-conducting member 24b as a second nip-forming member. The base 24a constitutes the body of the nip-forming member 24, and is formed by such heatproof resin as described below.

On the bottom surface (i.e. nipping part facing surface) of the base 24a is disposed the high heat-conducting member 24b. As illustrated in FIGS. 3A and 3B, the high heat-conducting member 24b is placed so as not to make contact with the stay 25 and the reflecting member 26 (see FIG. 2) disposed on the inward side of (or above) the stay 25. Therefore, heat-transfer from the high heat-conducting member 24b to the stay 25 is prevented, which is advantageous in terms of energy-conservation. Similarly, heat-transfer from the high heat-conducting member 24b to the reflecting member 26 is prevented as well, in order to maintain the advantage for energy-conservation.

(Base)

The base 24a needs to be of a pressure-transmittable organic or inorganic material, which has heat-conductivity lower than that of the high heat-conducting member 24b and is heat-resistant to tolerate operating temperature. Such material may be, for example, inorganic material (e.g. ceramic, glass, aluminum, etc.), rubber (e.g. silicone rubber, fluoro-rubber, etc.), fluorine resin (e.g. PTFE, PFA, ether and tetrafluoroethylene copolymer (ETFE), tetrafluoroethylene and hexafluoropropylene copolymer (FEP), etc.), resin (e.g. PI, polyamideimide (PAI), polyphenylenesulphide (PPS), polyetheretherketone (PEEK), LCP, phenol resin, nylon, aramid, etc.), or combination of such materials.

In the embodiment of the present invention, the base 24a is formed by LCP, which has preferable heat-resistance and formability. The heat-resistance temperature of the LCP is preferred to be more than 350° C. so as to tolerate increase in temperature on the end portions while papers are continuously passed through on the paper width of A6-portrait. Many of conventional bases 24a are heat-resistant to approximately 250° C., for which there has been a need to improve heat-resistance to tolerate such increase in temperature on the end portions.

The heat-conductivity of the base 24a is, for example, 0.54 W/m·K, which is extremely smaller than that of the high heat-conducting member 24b, stay 25, and reflecting member 26. Therefore, high heat-insulation effect is provided due to the base 24a, and therefore heat-transfer from the high heat-conducting member 24b to the base 24a or stay 25 may be reduced. Obviously, the heat-conductivity of the base 24a is not limited to be as such.

The top surface (i.e. stay facing surface) of the base 24a is in such a form that a multiple number of first protrusions 24a2, which are arranged in two rows with respect to the lateral direction, are aligned in the longitudinal direction so that each of the multiple number of first protrusions 24a2 are apart from each other see FIG. 3A). FIG. 3A is a cross-sectional view taken along line a-a illustrated in FIG. 3B. As the top surface (i.e. stay facing surface) of the base 24a is in such an unleveled form that a multiple number of protrusions line up in the longitudinal direction, heat-dissipation towards the stay 25 may be reduced while enabling transmission of pressure from the stay 25 to the nipping part N. Therefore, lighting rates of the halogen heaters 23 may be reduced, so as to enhance heat-efficiency and energy-conservation performance.

Here, the arrangement of the first protrusions 24a2 is not limited to be in such a form that a multiple number of first protrusions 24a2, which are arranged in two rows with respect to the lateral direction, are aligned in the longitudinal direction, as described above. That is to say, the form may be as follows: 1) a form in which a multiple number of first protrusions 24a2, which are arranged in a single row with respect to the lateral direction, are aligned in the longitudinal direction, 2) a form in which two first protrusions 24a2 are arranged with respect to the lateral direction, 3) a form in which a multiple number of first protrusions 24a2 are arranged in a zigzag alignment.

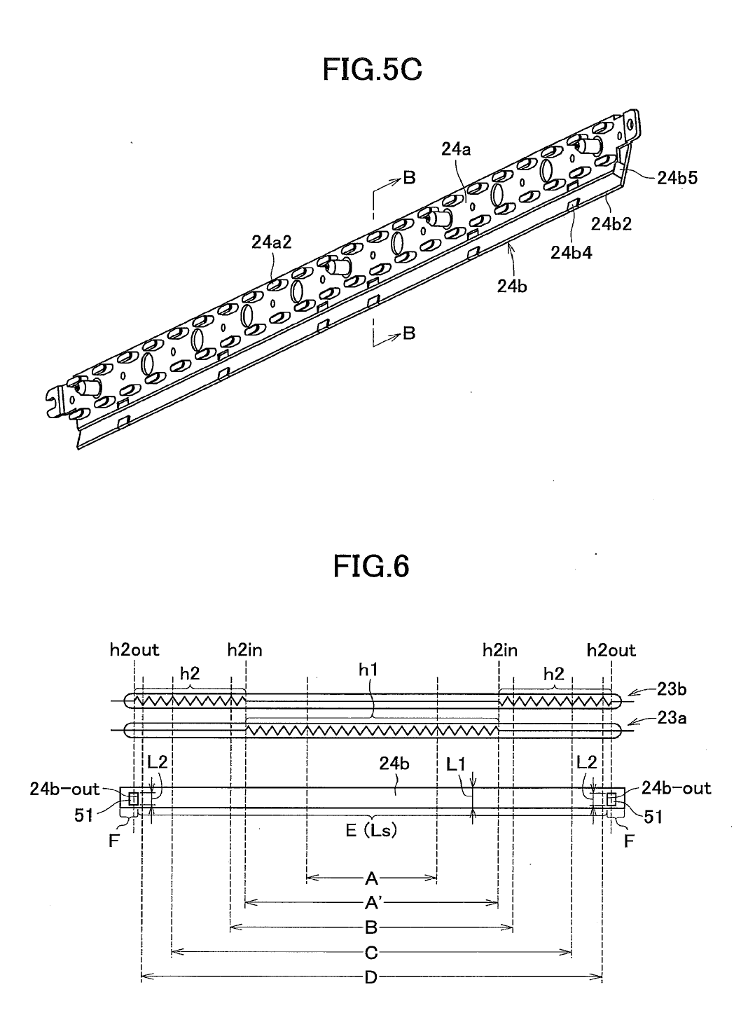

Furthermore, on the top surface of the base 24a is formed a concave portion 70 having a triangular cross-section, as illustrated in FIG. 3B. As illustrated in FIGS. 5A and 5B, the concave portion 70, which is provided for engaging with a below-described restraining portion 24b4 provided on the high heat-conducting member 24b, has a bottom surface, which slopes towards the nip surface in the lateral direction of the base 24a from the entry side to the exit side of the nipping part N, on the opposite surface (i.e. the top surface of the base 24a) of the surface facing the nipping part N. As illustrated in FIG. 5B, when the base 24a is inserted from left above to the inside of the concave cross-section of the high heat-conducting member 24b, the concave portion 70 passes through the bottom left corner of the restraining portion 24b4. Therefore, the tilt angle of the bottom surface is determined to be the same or larger than a tilt angle of the base 24a being inserted.

(High Heat-Conducting Member)

The high heat-conducting member 24b is formed by material with high heat-conductivity, in order to prevent increase in temperature on the end portions of the fixing belt 21. In a case where the base 24a of the fixing belt 21 is formed by metal such as nickel or SUS, the high heat-conducting member 24b is preferably formed by material with high heat-conductivity such as copper-based material (e.g. heat-conductivity: 381 W/m·K) or aluminum-based material (e.g. heat-conductivity: 236 W/m·K). In a case where the base 24a of the fixing belt 21 is formed by resin material such as polyimide (heat-conductivity: 0.29 W/m·K), the high heat-conducting member 24b may be formed by metal material such as iron-based SUS material (e.g. heat-conductivity: 19 W/m·K).

In the embodiment of the present invention, the high heat-conducting member 24b is formed by copper-based material, which is further specifically copper-based material with heat-conductivity of more than 236 W/m·K. In the embodiment of the present invention, a copper plate with such heat-conductivity is bent to form the high heat-conducting member 24b. In the examples of FIGS. 3A and 3B, a copper plate is bent to form the high heat-conducting member 24b having a concave cross-section in a direction orthogonal to the longitudinal direction. Here, a copper plate need not be bent, but may be welded to form such a shape.

Thickness and heat-capacity of the high heat-conducting member 24b are determined so as not to have a negative effect on first-print-time or rise-time for heating up the fixing belt 21. In a case where heat-capacity of the high heat-conducting member 24b is too high, amount of heat transferred away from the fixing belt 21 increases to the extent that heating-up of the fixing belt 21 is hindered, which results in delay in rise-time and first-print-time, and that lighting rates of the halogen heaters 23 increase, which results in deterioration of energy-conservation performance.

Therefore, the high heat-conducting member 24b is formed by material with low heat-capacity to be a thin layer, in order to prevent increase in temperature on the end portions while ensuring energy-conservation performance. In the embodiment of the present invention, the thickness of the high heat-conducting member 24b is thinner than 1 mm, more preferably thinner than 0.4 mm. In such a way, the high heat-conducting member 24b is formed to be a thin layer with a minimum level of heat-capacity that is necessary, in order to prevent a fixing malfunction caused by decrease in temperature on the end portions at rise-time for fixing.

As illustrated in FIG. 5A, the high heat-conducting member 24b has a bottom-wall portion 24b1 as a first surface of the concave cross-section, which is a nipping part facing surface, and has side-wall portions 24b2 and 24b3 on the left and right in the lateral direction of the high heat-conducting member 24b, which are bends towards the stay 25 to have a predetermined height Hs so as to fasten the base 24a with respect to the paper-passing direction. The height of the bends (i.e. the height of the side-wall portions 24b2 and 24b3) is determined to be higher than the thickness of the base 24a in the vertical direction. Here, although the height Hs of the side-wall portions 24b2 and 24b3 is fixed in the example illustrated in FIG. 5A, the height Hs may vary in the longitudinal direction of the high heat-conducting member 24b. In such a way, amount of heat released in the vertical direction of the high heat conducting member 24b may be adjusted, depending on positions in the longitudinal direction, in order to restrain increase in temperature on the end portions more properly.

In the embodiment of the present invention, in a case where the fixing unit 20 is a “A3-novi-supporting fixing unit”, the height Hs of the side-wall portions 24b2 and 24b3 provided on the high heat-conducting member 24b are determined to be in a range of 1.0 mm through 1.9 mm over the whole length in the longitudinal direction of the high heat-conducting member 24b, as illustrated in FIGS. 5A and 5B. Here, the height Hs is a measurement from the interior surface of the bottom-wall portion 24b1 to the top ends of the side-wall portions 24b2 and 24b3 of the high heat-conducting member 24b. Further, A3-novi is a non-standard size of a paper slightly larger than A3, which is a standard size, having a landscape width of 320 through 330 mm.

(Restraining Portion)

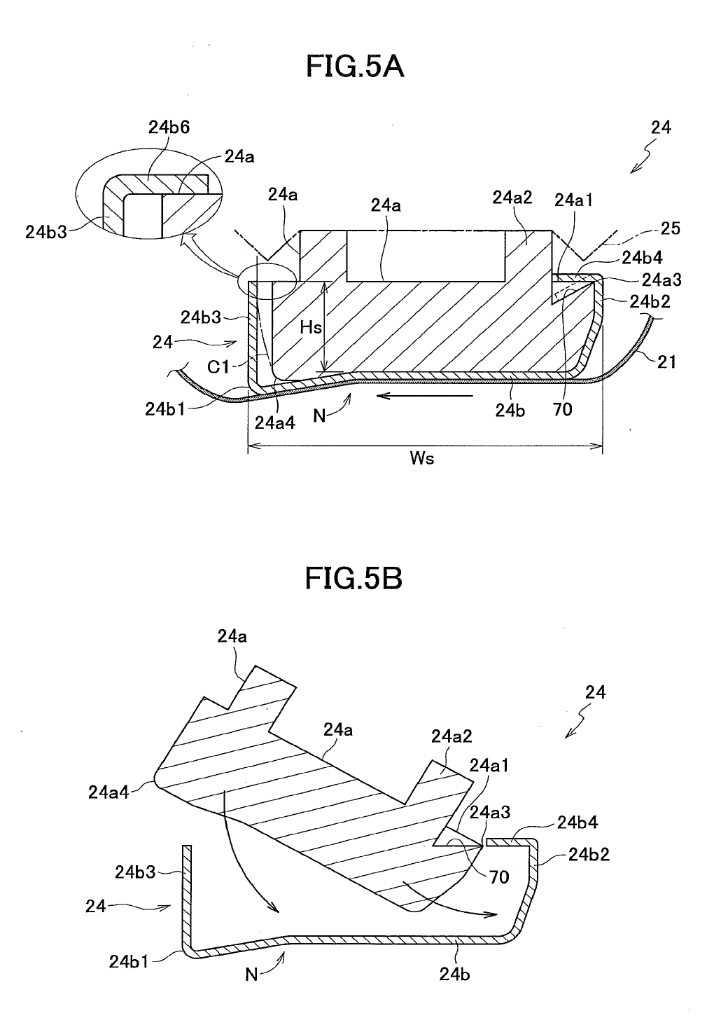

The top end part of the side-wall portion 24b2, which is formed on the high heat-conducting member 24b on the entry side of the nipping part N, is provided with the restraining portion 24b4 in a rectangular shape, which is an approximate right angle bend formed towards the downstream side of the rotation of the fixing belt 21, in other words, formed to have an L-shaped cross-section. As illustrated in FIGS. 4A and 4B, a multiple number of restraining portions 24b4 are formed at predetermined intervals a through c along the longitudinal direction of the high heat-conducting member 24b. With respect to formation of the restraining portion 24b4, which may be performed by bending or welding, a part of the high heat-conducting member 24b is bent to form the restraining portion 24b4 as described above, so that the restraining portion 24b4 may be formed without employing extra parts and with low cost. Further, the restraining portion 24b4 need not be a right angle bend, and may be any type of bends as long as the restraining portion 24b4 faces the bottom-wall portion 24b1 provided on the high heat-conducting member 24b, in order to achieve a detachment-preventing effect.

Length of the restraining portion 24b4 in the lateral direction is required to be the same or shorter than the thickness of the base 24a and the height of the high heat-conducting member 24b on the exit side (i.e. left side in FIGS. 5A and 5B). Thus, for example, in a case where the thickness of the base 24a and the height of the high heat-conducting member 24b on the exit side are 2 mm, the length of the restraining portion 24b4 in the lateral direction is determined to be 2 mm or shorter.

As the length of the restraining portion 24b4 in the lateral direction is determined to be 2 mm, the base 24a is easily attached and difficultly detached when inserting the base 24a to the inside of the concave cross-section of the high heat-conducting member 24b, and also an amount of heat released through the restraining portion 24b4 to the back side of the nip is reduced. That is to say, in a case where the length of the restraining portion 24b4 in the lateral direction is longer, it is more difficult for the base 24a to be engaged, and therefore the concave portion 70 provided on the base 24a is required to be larger, which means that strength of the base 24a is compromised. Contrarily, in a case where the length of the restraining portion 24b4 in the lateral direction is shorter, it is easier for the base 24a to be engaged with the inside of the concave cross-section of the high heat-conducting member 24b, although the base 24a is detached more easily.

As the restraining portion 24b4 is engaged with the top surface of the base 24a, which is on the opposite side of the nipping part N, on the upstream side of the rotation of the fixing belt 21, positional misalignment and deformation of the high heat-conducting member 24b, which are caused by friction against the fixing belt 21, may be prevented even though the high heat-conducting member 24b is designed to be thin-walled. Further, as the restraining portion 24b4 prevents detachment of a part at the time of assembling the nip-forming member 24, operation efficiency for assembling the nip-forming member 24 may be enhanced. That is to say, at the time of assembling the nip-forming member 24, the restraining portion 24b4 restrains the base 24a, which is accommodated inside the concave cross-section of the high heat-conducting member 24b, not to be detached upward from the state illustrated in FIG. 5A. Here, alternatively or at a right angle to the restraining portion 24b4 provided on the upstream side of the rotation of the fixing belt 21, a restraining portion 24b6 in a rectangular shape, which is a bend formed orthogonally towards the upstream side of the rotation of the fixing belt 21, may be provided on the top end part of the side-wall portion 24b3 on the downstream side of the rotation, as illustrated in a round frame appearing in FIG. 5A.

As illustrated in FIGS. 3, 5A, and 5B, the concave portion 70 engageable with the edge of the restraining portion 24b4 may be formed on the top surface 24a1 of the base 24a, as needed. In a case where the restraining portion 24b6 is formed on the downstream side of the rotation of the fixing belt 21, the concave portion 70 may be formed on the side of the base 24a opposite to the nipping part N at a position corresponding to the restraining portion 24b6, as needed. In such a way, deterioration in image quality caused by temperature unevenness of the nip-forming member 24 in the longitudinal direction may be prevented, as described below.

Providing the concave portion 70 may prevent the restraining portion 24b4 from being an obstacle when the base 24a is inserted at an angle to the concave cross-section of the high heat-conducting member 24b in such a way as indicated by an arrow illustrated in FIG. 5B. Needless to say, positional misalignment and deformation of the high heat-conducting member 24b may be prevented even though the concave portion 70 is not formed and the restraining portion 24b4 is at the position illustrated with a solid line in FIG. 5A.

For inserting the base 24a having the above-described concave portion 70, the concave portion 70 is rotated to a horizontal state from a position where an edge portion 24a3 on a side illustrated in FIG. 5B makes contact with the interior side of the base end portion of the restraining portion 24b4. In FIG. 5A is illustrated an inserted state. When being inserted, an edge portion 24a4 on the opposite side of the edge portion 24a3 on the base 24a forms a trajectory C1 in an arc while being slid on the surface of the side-wall portion 24b3. Here, as the high heat-conducting member 24b is designed to be thin-walled, one or both of the side-wall portions 24b2 and 24b3 may be elastically deformed outwards, for inserting the base 24a. In a case where the base 24a is inserted in such a way, a gap provided on the interior side of the side-wall portion 24b3 as illustrated in FIG. 5A is not necessary.

After the base 24a is inserted to the concave cross-section of the high heat-conducting member 24b, the restraining portion 24b4 is pressed downwards by use of a jig, etc., as illustrated with a broken line in FIG. 5A, so as to be bent into the concave portion 70 for engagement. The base 24a and the high heat-conducting member 24b may be unified in such a way, so that the above-described positional misalignment and deformation may be more securely prevented.

Here, in a case of letting remain a gap between the edge of the restraining portion 24b4 and the concave portion 70, temperature of the base 24a on a position corresponding to the restraining portion 24b4 (i.e. a position of the concave portion 70) may be almost event with on other positions in the longitudinal direction. That is to say, the restraining portion 24b4 may be kept at the position illustrated with the solid line in FIG. 5A or, in a case of being bent, the restraining portion 24b4 may be slightly bent with pressure downwards by use of a jig, etc., so that the gap remains. In such a way, deterioration in image quality caused by temperature unevenness of the nip-forming member 24 in the longitudinal direction may be prevented.

Furthermore, as engagement of the restraining portion 24b4 and the concave portion 70 has a thrust-prevention effect as described below, below-described engaging portions 24b5 on the end portions may not need to be provided. Further, as the concave portion 70 functions as a mark alternative to a triangle mark 60, the triangle mark 60 may not need to be provided as well.

For example, as the length of the nip-forming member 24 in the longitudinal direction is more than 300 mm in a case of supporting the width of A3-novi, it is difficult, with only one restraining portion 24b4 at the middle in the longitudinal direction, to maintain steady engagement (or a clinched state) with the base 24a over the whole length in the longitudinal direction. Thus, the restraining portion 24b4 may be provided on multiple positions (six positions in the embodiment of the present invention) of the high heat-conducting member 24b in the longitudinal direction, so as to sufficiently strengthen the clinched state over the base 24a in the whole length in the longitudinal direction.

With the restraining portion 24b4 being provided to a part, as described above, volume reduction of the restraining portion 24b4 becomes possible. Here, undesired increase in heat-capacity of the high heat-conducting member 24b at portions other than the bottom-wall portion 24b1 facing the nipping part N may be prevented, and therefore heat-conductivity of the bottom-wall portion 24b1 of the high heat-conducting member 24b is efficiently improved, so as to satisfy a required heat-equalizing function.

Further, even though force in a direction indicated by the arrow in FIG. 5A is applied to the high heat-conducting member 24b due to frictional resistance against the fixing belt 21 at the time of operation of the fixing belt 21 where the fixing belt 21 rotates in the direction indicated by the arrow, possibility for positional misalignment and deformation of the base 24a and the high heat-conducting member 24b may be reduced, as the restraining portion 24b4 is provided on the upstream side of the rotation of the fixing belt 21. Thus, a positional relation between the base 24a and the high heat-conducting member 24b may be steadily maintained. In such a way, a steady and long-term sliding function of the low-friction sheet, which is provided between the nip-forming member 24 and the fixing belt 21, and a high-quality fixing function of the image formation apparatus 1 may be ensured.

As illustrated in FIG. 4, the restraining portion 24b4 is formed at an interval a at the central section in the longitudinal direction of the high heat-conducting member 24b, which is shorter than intervals b and c at the end portions in the longitudinal direction of the high heat-conducting member 24b. As the high heat-conducting member 24b makes contact with the fixing belt 21 over the whole length in the longitudinal direction, distorting force due to friction force is the largest at the central section. Therefore, in order to attend to such distorting force, the interval a formed at the central section in the longitudinal direction is designed to be short. Length of the intervals b and c on end portions in the longitudinal direction may be equal. Alternatively, length of the interval c, which is on the outer section in the longitudinal direction, may be slightly longer, so that the intervals are in a relation of a<b<c, as the distorting force due to the friction force acting on the high heat-conducting member 24b is smaller on the outer section in the longitudinal direction.

Here, although a larger number of the restraining portion 24b4 may be provided in order to strengthen connection with the base 24a, providing with too many restraining portions 24b4 causes increase in heat-dissipation of the high heat-conducting member 24b, and therefore deteriorates energy-conservation performance. Thus, in the embodiment of the present invention, the number of the restraining portion 24b4 is determined to be six. Provided with six restraining portions 24b4, the amount of heat-dissipation may be kept in an acceptable range and an effect of preventing temperature-rise on end portions may be achieved.

As illustrated in FIG. 4A, on end portions in the longitudinal direction of the high heat-conducting member 24b is formed an engaging portion 24b5 in a rectangular shape, which is engageable with one of the end portions of the base 24a. The engaging portion 24b5 is formed on the end portions in the longitudinal direction of the bottom-wall portion 24b1 at right angle, in other words, so as to have an L-shaped cross-section, in a direction facing oppositely to the nipping part N.

The engaging portion 24b5 may prevent positional misalignment and deformation arose in the longitudinal direction when assembling the high heat-conducting member 24b and the base 24a (i.e. thrust-prevention effect). Thus, operation efficiency for assembling the nip-forming member 24 may be enhanced, in combination with the function of the restraining portion 24b4 for preventing the base 24a from being detached.

(Assembly of the Nip-Forming Member)

For assembling the nip-forming member 24, first, the base 24a is placed above and parallel to the concave cross-section of the high heat-conducting member 24b as illustrated in FIG. 5C, and then inserted in the direction indicated by the arrow illustrated in FIG. 5B, in other words, in an oblique direction, so that a side of the base 24a gets below the restraining portion 24b4. FIG. 5B is a cross-sectional view taken along line B-B illustrated in FIG. 5C. Once the base 24a fits inside the concave cross-section as illustrated in FIG. 5A, even though force is applied to upwardly detach the base 24a, the restraining portion 24b4 prevents the base 24a from upwardly being detached. Thus, the base 24a is restrained not to be detached from the concave cross-section of the high heat-conducting member 24b. Therefore, the base 24a and the high heat-conducting member 24b steadily stay engaged with each other, and accordingly assembly of the nip-forming member 24 may be smoothly performed.

As illustrated in an enlarged view appearing in FIG. 4A, the triangle mark 60 may be formed convexly or concavely on the top surface 24a1 of the base 24a at a position to be clinched by the restraining portion 24b4. In such a way, a position of the restraining portion 24b4 corresponding to the base 24a may be easily determined.

Furthermore, as illustrated in FIG. 4B, a concave portion 71 in the same shape as the restraining portion 24b4 with a predetermined depth may be formed at a position to be clinched by the restraining portion 24b4, alternatively to the aforementioned concave portion 70, so that the concave portion 71 is entirely engaged by the restraining portion 24b4. As the concave portion 71 is entirely engaged by the restraining portion 24b4, no protuberance is made on the top surface 24a1 of the base 24a due to the restraining portion 24b4. In such a way, compactification of the unit may be achieved, as the gap between the base 24a and the stay 25, which is arranged above the base 24a, may be narrower. Furthermore, as engagement of the restraining portion 24b4 with the concave portion 71 has the thrust-prevention effect for the base 24a and the high heat-conducting member 24b, the engaging portions 24b5 on the end portions may not be provided. Further, as the concave portion 71 functions as a mark alternative to the triangle mark 60, the triangle mark 60 may not be provided as well.

(Arrangement-Relation Between the Halogen Heaters and the High Heat-Conducting Member)

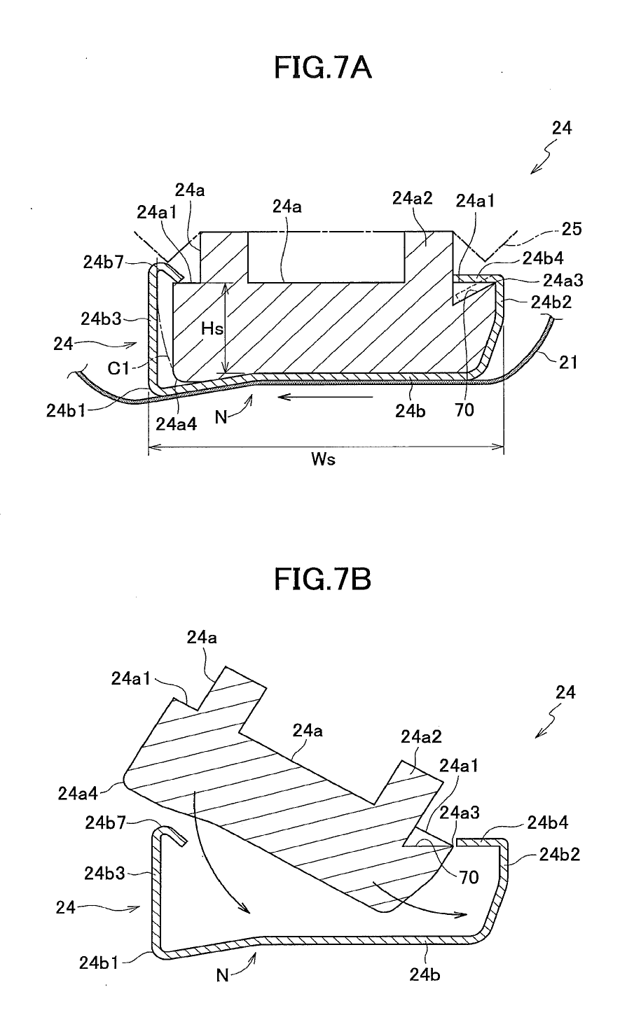

Lastly, the following description explains an arrangement-relation between the halogen heaters 23 and the high heat-conducting member 24b, with reference to FIG. 6. In FIG. 6, width-sizes of papers passing through the fixing unit 20 are expressed by A through D (i.e. A: letter, A′: A4-portrait, B: B4-portrait, C: A3-portrait, D: A3-novi).

The high heat-conducting member 24b is arranged parallel to the halogen heaters 23. In the embodiment of the present invention, the central heater 23a and end heater 23b having different heating regions, respectively, are employed as the halogen heaters 23. Here, one single heater that functions as the halogen heaters 23 may be employed alternatively.

The central heater 23a has a heating portion (i.e. emission portion) h1 at the central section in a lateral direction of the fixing belt 21, whereas the end heater 23b has heating portions (i.e. emission portions) h2 at outer sections in the lateral direction of the fixing belt 21. Inner ends of the heating portions h2 of the end heater 23b (i.e. end portions of the central section in the lateral direction of the fixing belt 21) are arranged to be at positions corresponding to the end portions of the heating portion h1 of the central heater 23a, respectively.

Length Ls of the high heat-conducting member 24b is determined so that both outer ends 24b-out in the longitudinal direction of the high heat-conducting member 24b are arranged to be in ranges corresponding to regions from inner ends h2in to respective outer ends h2out in the longitudinal direction of the heating portions h2 provided on the end heater 23b. Here, in the embodiment of the present invention, positions of inner ends in the lateral direction of openings 51 formed on the ends of the high heat-conducting member 24b in the longitudinal direction are referred to as the outer ends 24b-out in the longitudinal direction of the high heat-conducting member 24b.

The openings 51 are provided for the purpose of positioning of the high heat-conducting member 24b relative to the base 24a of the nip-forming member 24. The position of the high heat-conducting member 24b relative to the base 24a in the longitudinal direction is determined in a way that protrusions which are provided on the base 24a as position-determining portions are inserted to the openings 51.

Sections of the high heat-conducting member 24b on which the openings 51 are formed have smaller dimensions to make contacts with the fixing belt 21, and therefore have less function to conduct heat from the sections with openings 51 to outer sections in the longitudinal direction. Especially, in the embodiment of the present invention, a length L2 of the openings 51 in the paper-conveyance direction (i.e. lengths in the recording medium conveyance direction) are longer than half a length L1 of the high heat-conducting member 24b in the paper-conveyance direction (i.e. lengths in the recording medium conveyance direction). Thus, amount of heat conducted from the sections with openings 51 to the outer sections in the longitudinal direction is reduced.

That is to say, in the embodiment of the present invention, among the region of the high heat-conducting member 24b in the longitudinal direction, a region E, which extends from the center to the openings 51 in the longitudinal direction, is a section where a function as a heat-conducting portion is expected the most. Contrarily, regions F, which are outer sections of the openings 51 in the longitudinal direction, are sections which are provided mainly for a function as position-determining portions, having the function to conduct heat less than the heat-conducting portion.

For such a reason described above, in the embodiment of the present invention, among the constituent portions of the high heat-conducting member 24b, the outer ends in the longitudinal direction of the heat-conducting portion (i.e. region E) (or the inner ends in the lateral direction of the openings 51), which is mainly expected for the function as the heat-conducting member, are referred to as the outer ends 24b-out in the longitudinal direction of the high heat-conducting member 24b. Here, unlike the embodiment of the present invention, in a case where the lengths L2 of the openings 51 in the paper-conveyance direction are shorter than half the length L1 of the high heat-conducting member 24b in the paper-conveyance direction, the outer sections (i.e. regions F) of the openings 51 in the longitudinal direction are determined to function mainly as the heat-conducting portions. Therefore, in such a case, the outer ends in the longitudinal direction of the entire high heat-conducting member 24b, including the outer sections (i.e. regions F) of the openings 51 in the longitudinal direction, are referred to as the outer ends 24b-out in the longitudinal direction of the high heat-conducting member 24b.

Further, the present invention is not limited to these embodiments, but various variations and modifications may be made without departing from the scope of the present invention. For example, the number of the arranged restraining portions 24b4 may be increased to more than 6 or decreased to less than 6, in accordance with the length of the nip-forming member 24, etc. Furthermore, the shape of the restraining portion 24b4 is not limited to rectangular, and may be modified to square, triangle, trapezoid, etc.

Furthermore, as a variation of the nip-forming member 24, a required number of restraining portions 24b7 may be formed on the side-wall portion 24b3 on the downstream side of the high heat-conducting member 24b, as illustrated in FIGS. 7A through 7C. The restraining portion 24b7 rises and curls in a reversed U-shape at the top end of the side-wall portion 24b3, so that the edge portion abuts the top surface 24a1 of the base 24a as illustrated in FIG. 7A. In such a variation, the restraining portion 24b7 is provided with a function to guide the edge portion 24a4 of the base 24a to the concave cross section of the high heat-conducting member 24b when the base 24a is inserted at an angle to the concave cross-section in such a way as indicated by an arrow illustrated in FIG. 7B. As the edge portion of the restraining portion 24b7 abuts the top surface 24al of the base 24a once the base 24a is inserted to the concave cross-section, detachment of the base 24a from the concave cross-section is prevented. Thus, assembly of the nip-forming member 24 may be smoothly performed.

The restraining portions 24b7 on the downstream side are preferred to be arranged alternately between two restraining portions 24b4 on the upstream side, as illustrated in FIG. 7C. In such a way, the positional relation between the base 24a and the high heat-conducting member 24b may be steadily maintained. Furthermore, in a case where the restraining portions 24b4 on the upstream side and the restraining portions 24b7 on the downstream side are alternately arranged in the longitudinal direction of the high heat-conducting member 24b as illustrated in FIG. 7C, temperature-rise attribute in the longitudinal direction of the high heat-conducting member 24b may be equalized, and accordingly rise-time for heating up the fixing belt 21 and first-print-time may be shortened.

What is claimed is:

1. A nip-forming member arranged in contact with an inner circumferential surface of a rotatable endless fixing belt, the nip-forming member being counter-acted by a counterpart member from an outer circumferential side of the fixing belt so as to form a nipping part, which is a contacting section of the fixing belt and the counterpart member, the nip-forming member comprising:
a first nip-forming member configured to be a main body of the nip-forming member; and
a second nip-forming member disposed on a surface of the first nip-forming member, the surface facing the inner circumferential surface of the fixing belt, the second nip-forming member extending in a direction orthogonal to a rotating direction of the fixing belt,
wherein both ends of the second nip-forming member on an upstream side and a downstream side of the rotating direction of the fixing belt are bent in a direction away from the nipping part, in order to create a pair of side-wall portions, so that the second nip-forming member has a concave cross-section for accommodating the first nip-forming member, and
wherein the second nip-forming member has a restraining portion at a position located on the side-wall portion created on the upstream side of the rotating direction, the restraining portion being configured to restrain the first nip-forming member not to be detached from the concave cross-section.

2. The nip-forming member according to claim 1, wherein the restraining portion is formed at a plurality of positions on the second nip-forming member along the direction orthogonal to the rotating direction of the fixing belt.

3. The nip-forming member according to claim 2, wherein the restraining portion is formed at a shorter interval at a central section of the second nip-forming member, compared to at end sections of the second nip-forming member, in the direction orthogonal to the rotating direction of the fixing belt.

4. The nip-forming member according to claim 1, wherein the pair of side-wall portions created on the upstream side and the downstream side of the rotating direction are both longer than a length of the first nip-forming member in the direction away from the nipping part.

5. The nip-forming member according to claim 1, wherein the side-wall portion created on the upstream side of the rotating direction of the fixing belt is bent towards the downstream side of the rotating direction of the fixing belt, in order to create the restraining portion.

6. The nip-forming member according to claim 5, wherein the restraining portion is in a rectangular shape having a longitudinal side parallel to the direction orthogonal to the rotating direction of the fixing belt.

7. The nip-forming member according to claim 1, wherein an engaging portion is formed on the second nip-forming member at end portions in the direction orthogonal to the rotating direction of the fixing belt, the engaging portion being configured to engage with the first nip-forming member at end portions in the direction orthogonal to the rotating direction of the fixing belt.

8. The nip-forming member according to claim 1, wherein the first nip-forming member has a mark on a surface that is opposite to the surface facing the inner circumferential surface of the fixing belt, the mark corresponding to the position at which the restraining portion is formed.

9. The nip-forming member according to claim 1, wherein the first nip-forming member has a concave portion on the surface that is opposite to the surface facing the inner circumferential surface of the fixing belt, the concave portion being engageable with the restraining portion.

10. A nip-forming member arranged in contact with an inner circumferential surface of a rotatable endless fixing belt, the nip-forming member being counter-acted by a counterpart member from an outer circumferential side of the fixing belt so as to form a nipping part, which is a contacting section of the fixing belt and the counterpart member, the nip-forming member comprising:
a first nip-forming member configured to be a main body of the nip-forming member; and
a second nip-forming member disposed on a surface of the first nip-forming member, the surface facing the inner circumferential surface of the fixing belt, the second nip-forming member extending in a direction orthogonal to a rotating direction of the fixing belt,
wherein both ends of the second nip-forming member on an upstream side and a downstream side of the rotating direction of the fixing belt are bent in a direction away from the nipping part, in order to create a pair of side-wall portions, so that the second nip-forming member has a concave cross-section for accommodating the first nip-forming member, and
wherein the second nip-forming member has a restraining portion at a position located on at least one of the side-wall portion created on an upstream side of the rotating direction of the fixing belt and the side-wall portion created on a downstream side of the rotating direction of the fixing belt, the restraining portion being configured to restrain the first nip-forming member not to be detached from the concave cross-section.

11. The nip-forming member according to claim 1, wherein the second nip-forming member has higher heat-conductivity than that of the first nip-forming member.

12. A fixing unit comprising:
a rotatable endless fixing belt;
a heat applying member configured to apply heat to the fixing belt;
a nip-forming member arranged in contact with an inner circumferential surface of the fixing belt; and
a counterpart member configured to counter-act the nip-forming member from an outer circumferential side of the fixing belt so as to form a nipping part, which is a contacting section of the counterpart member and the fixing belt,
wherein the nip-forming member includes:
a first nip-forming member configured to be a main body of the nip-forming member; and
a second nip-forming member disposed on a surface of the first nip-forming member, the surface facing the inner circumferential surface of the fixing belt, the second nip-forming member extending in a direction orthogonal to a rotating direction of the fixing belt,
wherein both ends of the second nip-forming member on an upstream side and a downstream side of the rotating direction of the fixing belt are bent in a direction away from the nipping part, in order to create a pair of side-wall portions, so that the second nip-forming member has a concave cross-section, and
wherein the second nip-forming member has a restraining portion at a position located on the side-wall portion created on the upstream side of the rotating direction of the fixing belt, the restraining portion being configured to restrain the first nip-forming member not to be detached from the concave cross-section.

13. An image forming apparatus, which is electrophotographic image forming apparatus that transfers a toner image onto a recording medium and then performs a fixing process to form an image, the image forming apparatus comprising:
an image bearer supported rotatably;
a charging unit configured to charge the image bearer;
a latent image forming unit configured to form an electrostatic latent image on the image bearer charged by the charging unit;
a developing device configured to attach toner onto the electrostatic latent image formed by the latent image forming unit, in order to visualize the electrostatic latent image in a form of a toner image;
a transfer unit configured to transfer the toner image formed by the developing device onto the recording medium; and
the fixing unit according to claim 12, the fixing unit being configured to fix the toner image transferred onto the recording medium by the transfer unit.
